(19) United States
(12) Patent Application Publication
(10) Pub. No.: US 2011/0260529 A1
(43) Pub. Date: Oct. 27, 2011

(54) ON-DEMAND ELECTRIC POWER CONTROL STRATEGY

(75) Inventor: Akram R. Zahdeh, Rochester Hills, MI (US)

(73) Assignee: GM GLOBAL TECHNOLOGY OPERATIONS, INC., Detroit, MI (US)

(21) Appl. No.: 12/765,389

(22) Filed: Apr. 22, 2010

(51) Int. Cl. B60L 1/00; H02K 23/52

(52) U.S. Cl. 307/10.1; 290/46

(57) ABSTRACT

A motor vehicle includes an internal combustion engine configured to generate engine power, and a transmission operatively connected to the internal combustion engine and configured to transmit the engine power for driving the vehicle. The vehicle additionally includes a three-phase electrical device configured to operate on three-phase power, and an alternator operatively connected to the engine. The alternator is configured to operate on three-phase electric power, to supply un-rectified three-phase power to directly operate the three-phase electrical device, and to cease supplying power when the engine is off.

### TECHNICAL FIELD

The invention relates to an on-demand electric power control strategy in a vehicle employing an internal combustion engine.

### BACKGROUND OF THE INVENTION

A majority of modern vehicles employs internal combustion engines for propulsion. In search of reduced exhaust emissions, as well as for improved fuel efficiency, some vehicles employ electric motor/generators that combine with an internal combustion engine to form a hybrid powertrain. Also for reduced exhaust emissions and improved fuel efficiency, some other vehicles incorporate internal combustion engines with start-stop capability.

Start-stop capability allows the engine to be automatically shut off when the vehicle comes to a stop and then be automatically restarted when the vehicle operator releases the subject vehicle's brake pedal. Generally, start-stop capability reduces the engine's emissions and improves the vehicle's overall fuel efficiency since the engine does not consume fuel or produce post-combustion exhaust when the vehicle is stopped.

As employed in any of the above powertrains, an internal combustion engine is often used to drive an alternator that is configured to produce electric power for running various vehicle accessories and sub-systems, as well as for charging an on-board energy-storage device. In an engine having a start-stop capability, an alternator/motor may be specifically designed to quickly restart an engine that has been shut off, when vehicle motion is again desired.

### SUMMARY OF THE INVENTION

A motor vehicle includes an internal combustion engine configured to generate engine power, and a transmission operatively connected to the internal combustion engine and configured to transmit the engine power for driving the vehicle. The vehicle additionally includes a three-phase electrical device configured to operate on three-phase power, and an alternator operatively connected to the engine. The alternator is configured to operate on three-phase electric power, to supply un-rectified three-phase power to directly operate the three-phase electrical device, and to cease supplying power when the engine is off.

The engine may include an automatic start/stop capability. The alternator may be a belt-driven alternator-starter (BAS) configured, i.e., sized and adapted, to selectively start the engine and be driven by the engine.

The vehicle may additionally include a controller to regulate the operation of the alternator. The three-phase electrical device may be an electric fluid pump arranged to supply fluid to the engine, such as a resistance heater, i.e., an energy dissipating device configured to emit thermal energy. The resistance heater may be adapted to supply thermal energy to oil in the transmission or to oil in the engine, to thereby increase temperature of the respective oil.

The vehicle may also include a heating ventilation and air conditioning (HVAC) system, and the energy dissipating device may then be a heating element adapted to increase temperature of the air supplied by the HVAC system. The vehicle may furthermore include a rectifier and an energy-storage device, and the alternator may supply rectified power via the rectifier to the energy-storage device.

The engine may include an exhaust catalyst, and the resistance heater may then be adapted to increase operating temperature of such a catalyst.

A method and a system for operating a three-phase electrical device via the alternator in a vehicle are also disclosed.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic plan view of a vehicle employing a three-phase alternator to directly operate a three-phase electrical device; and

FIG. 2 is a flow chart illustrating a method for operating the three-phase electrical device via the alternator in the vehicle depicted in FIG. 1.

### DESCRIPTION OF THE PREFERRED EMBODIMENTS

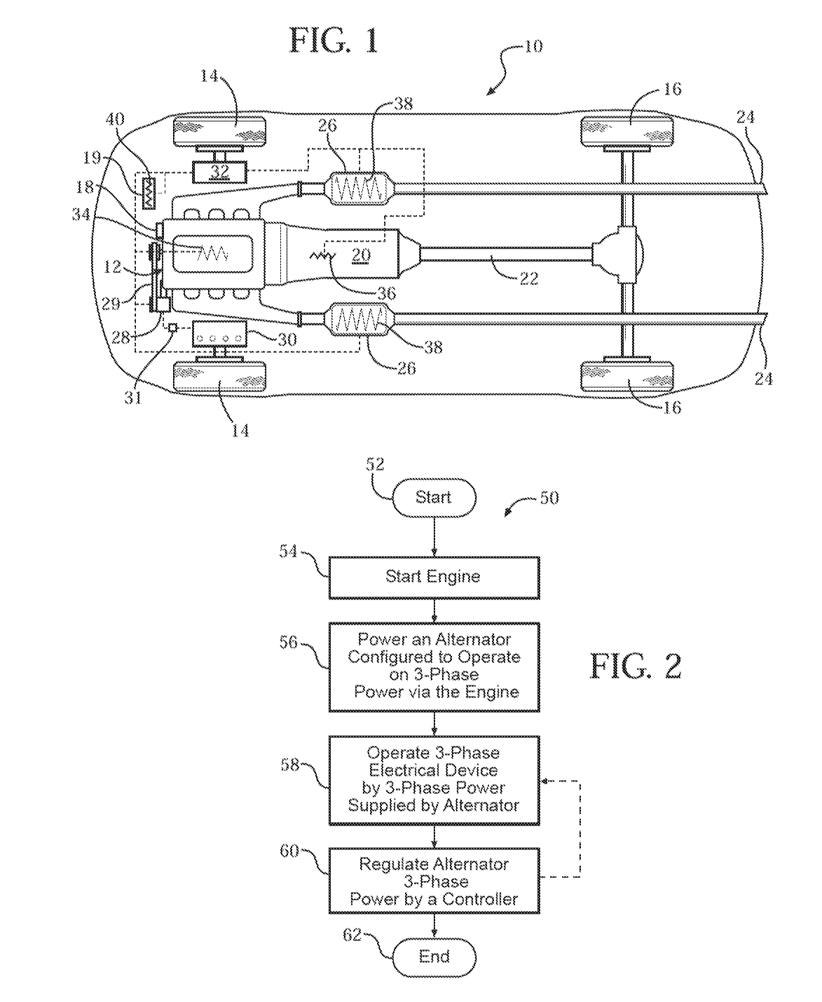

Referring to the drawings, wherein like reference numbers refer to like components, FIG. 1 shows a schematic view of a hybrid electric vehicle (HEV) 10. The HEV 10 includes an internal combustion engine 12, such as a spark or a compression ignition type engine, configured to generate power and adapted for driving wheels 14 and/or wheels 16 to propel the vehicle. Although a hybrid electric vehicle is shown, any vehicle employing an internal combustion engine is envisioned.

Engine 12 includes a start-stop capability, wherein the engine automatically shuts-off as HEV 10 comes to a stop and restarts as the vehicle operator releases the brakes (not shown). Engine 12 includes an electric fluid pump 18, adapted to supply pressurized fluid and circulate such fluid throughout the engine to affect engine cooling. Fluid pump 18 is a three-phase electric device configured to operate on un-rectified three-phase electric power, as understood by those skilled in the art. The HEV 10 additionally includes a heating ventilation and air conditioning (HVAC) system 19 for supplying outside air to the vehicle's passenger compartment.

Employing an electric fluid pump 18 in place of a mechanically-driven fluid pump permits more efficient operation of engine 12. A typical mechanically-driven fluid pump is generally sized to provide sufficient fluid flow and pressure for low rpm engine operation, such as idle and cruising speeds. Therefore, because the speed of the mechanical fluid pump is proportional to engine rpm, fluid flow and pressure at higher engine speeds frequently exceed that which are required for reliable engine operation. Operating a mechanical fluid pump at such unnecessarily high fluid pump rotational speeds, however, reduces engine efficiency by putting additional load on the engine, and may consume as much as 10 horsepower from the engine's power output. Electric fluid pump 18 resolves such an efficiency concern by permitting the three-phase electrical current for driving the pump to be regulated according to subject engine's lubrication demands during specific operating conditions. Additionally, when fluid flow is not required, pump 18 may be shut off by a relatively inexpensive electrical relay, while a mechanically-driven fluid pump would necessitate the use of a costly mechanical clutch, as understood by those skilled in the art.

The engine 12 transmits power to the driven wheels 14 and/or 16 through a transmission 20 via a drive or a propeller shaft 22 for driving HEV 10. The engine 12 emits gases that are a product of the combustion process via an exhaust system 24 to the ambient. The exhaust system 24 includes catalytic converters 26 that are employed to reduce toxicity of the emitted exhaust gases prior to the gases entering the atmosphere, as understood by those skilled in the art. Engine 12, wheels 14 and 16, transmission 20, and propeller shaft 22 are all part of a driveline of the HEV 10.

Still referring to FIG. 1, HEV 10 additionally includes a belt-driven alternator 28 configured to generate electrical power and supply such power to various electrical devices of HEV 10. Alternator 28 is shown as an alternator-starter (BAS) configured, i.e., sized and adapted, to selectively start the engine, as well as be driven by the engine 12 to supply power to various electrical devices of HEV 10. An alternator 28 configured as a BAS is generally a motor/generator sized to quickly and automatically restart engine 12 after the engine has been shut off, and when operator of the vehicle releases the brakes, as understood by those skilled in the art. Whether configured to function only as a generator or as a BAS, the alternator 28 is operatively connected to the engine 12 via a belt 29, and is configured to be driven by the engine when the engine is running.

Alternator 28 is configured to operate on three-phase electric power, as understood by those skilled in the art. When engine 12 is running, alternator 28 supplies alternating current (AC) and three-phase power directly, i.e., without passing through any rectifiers, to operate a three-phase electrical device. By using AC power in place of direct current (DC) power, gage thickness of the wiring connections may be reduced, thereby reducing weight and cost of HEV 10. Additionally, three-phase operation permits power to be ramped up quicker and to higher levels than is possible with DC, thereby achieving a more rapid response from a particular three-phase electrical device. Because alternator 28 is driven directly by the engine 12, the alternator ceases supplying power when the engine is shut-off.

Alternator 28 is configured to supply energy in rectified DC form, to an energy-storage device 30, such as one or more batteries, when engine 12 is running. Three-phase power produced by alternator 28 is converted from AC to DC power via a rectifier 31, as understood by those skilled in the art. Energy-storage device 30 supplies electrical energy in DC form to power alternator 28 when engine 12 is shut-off to enable the alternator to start the engine. Energy-storage device 30 typically also supplies electrical energy to power other miscellaneous vehicle accessories, such as vehicle exterior and interior lighting (not shown). Energy-storage device 30 is configured to selectively store energy, and to release the stored energy as required by operation of HEV 10. The HEV 10 also includes a controller 32 adapted to regulate the operation of engine 12, transmission 20, alternator 28, and energy-storage device 30.

Engine 12 includes a resistance heater 34, wherein the resistance heater 34 acts as a three-phase electrical energy dissipating device. Resistance heater 34 supplies thermal energy to the oil inside engine 12 in order to more rapidly achieve a desired engine operating temperature. Engine 12 operates more efficiently, burns the fuel-air mixture more thoroughly, and therefore emits lower exhaust emissions when it operates at a certain predetermined operating temperature, as understood by those skilled in the art.

Transmission 20 includes a resistance heater 36, wherein the resistance heater 36 acts as a three-phase electrical energy dissipating device. Resistance heater 36 supplies thermal energy to the oil inside transmission 20 in order to more rapidly achieve a desired transmission operating temperature. Transmission 20 exhibits less internal parasitic drag, and therefore operates more efficiently when it operates at a certain predetermined operating temperature, as understood by those skilled in the art.

Still referring to FIG. 1, engine 12 may cool-off significantly when it is intermittently shut-off and restarted by the alternator 28 configured as a BAS during an automatic start/stop maneuver, such as in a stop-and-go phase of rush hour traffic. In such a case, upon re-start, engine 12 frequently exhibits increased exhaust gas emissions relative to the engine's fully warm state. In order to decrease exhaust emissions upon re-start, each catalytic converter 26 includes a resistance heater 38, wherein each of the resistance heaters 38 acts as a three-phase electrical energy dissipating device to supply thermal energy to each of the catalytic converters. Resistance heaters 38 are employed to efficiently light-off catalytic converters 26 to reduce cold-start exhaust emissions in place of supplying additional fuel to the engine 12, which is a common cold-start emission reduction strategy, as understood by those skilled in the art.

The HVAC system 19 includes a heating element 40, wherein the heating element 40 acts as a three-phase electrical energy dissipating device. Heating element 40 is adapted to provide thermal energy to the air supplied by the HVAC system to the passenger compartment of HEV 10. Heating element 40 supplements a heat exchanger (not shown) that is typically employed to transfer thermal energy from engine coolant to the air supplied by the HVAC system 19. Hence, heating element 40 is configured to increase temperature of air emitted by HVAC system 19 even when coolant of HEV 10 has not yet sufficiently warmed up.

Controller 32 is adapted to regulate the operation of alternator 28 to selectively or simultaneously supply three-phase power to resistance heaters 34, 36, 38, and heating element 40. Controller 32 may additionally drive such three-phase devices as an electric power steering pump and/or a cooling fan for a radiator, as understood by those skilled in the art. Controller 32 regulates three-phase power input from alternator 28 into fluid pump 18, resistance heaters 34, 36, 38, as well as heating element 40, according to a predetermined schedule, and per an algorithm programmed into the controller, as necessitated by operation of HEV 10. Controller 32 operates to vary the operating frequency of the three-phase current, thereby changing the speed of alternator 28 based on demand. The schedule programmed into the controller 32 via the algorithm is typically determined during the testing and validation phase of HEV 10 development, as understood by those skilled in the art.

FIG. 2 depicts a method 50 for operating a three-phase electrical device, such as fluid pump 18, resistance heaters 34, 36, 38, and heating element 40 in the HEV 10, as described above with respect to FIG. 1. The method commences in frame 52, and then proceeds to frame 54 where engine 12 is started. Following frame 54, alternator 28 is powered by engine 12 in frame 56, and then the method moves to frame 58. In frame 58, at least one three-phase electrical device, such as fluid pump 18, resistance heaters 34, 36, 38, and heating element 40, is operated directly via un-rectified three-phase electric power supplied by alternator 28. After frame 58, un-rectified three-phase electric power supplied by alternator 28 is regulated by controller 32 according to a predetermined schedule in frame 60. Following frame 60, the method may loop back to frame 58 to operate another three-phase electrical device, or proceed to frame 62 where the method is completed.

While the best modes for carrying out the invention have been described in detail, those familiar with the art to which this invention relates will recognize various alternative designs and embodiments for practicing the invention within the scope of the appended claims.

1. A motor vehicle comprising:
an internal combustion engine configured to generate engine power;
a transmission operatively connected to the engine, and configured to transmit the engine power for driving the vehicle;
an alternator operatively connected to the engine, the alternator configured to operate on three-phase electric power, to be driven by the engine, and to cease supplying power when the engine is off; and
a three-phase electrical device configured to operate on three-phase power;
wherein the alternator is configured to supply un-rectified three-phase power to directly operate the three-phase electrical device.

2. The vehicle according to claim 1, wherein the engine includes an automatic start/stop capability, and the alternator is a belt-driven alternator-starter (BAS) configured to selectively start the engine.

3. The vehicle according to claim 1, further comprising a controller to regulate the operation of the alternator.

4. The vehicle according to claim 1, wherein the three-phase electrical device is an electric fluid pump arranged to supply fluid to the engine.

5. The vehicle according to claim 1, wherein the three-phase electrical device is a resistance heater.

6. The vehicle according to claim 5, wherein the resistance heater is adapted to provide thermal energy to one of oil in the transmission and oil in the engine.

7. The vehicle according to claim 5, wherein the engine additionally includes an exhaust catalyst and the resistance heater is adapted to provide thermal energy to the exhaust catalyst.

8. The vehicle according to claim 5, further comprising a heating, ventilation and, air conditioning (HVAC) system, and wherein the three-phase electrical device is a heating element adapted to provide thermal energy to the air supplied by the HVAC system.

9. The vehicle according to claim 1, further comprising a rectifier and an energy-storage device, and wherein the alternator supplies rectified power via the rectifier to the energy storage-device.

10. A method for operating a three-phase electrical device in a vehicle having an internal combustion engine, and a transmission operatively connected to the internal combustion engine and configured to transmit engine power for driving the vehicle, the method comprising:
starting an internal combustion engine;
powering an alternator via the internal combustion engine, wherein the alternator is configured to operate on three-phase electric power;
directly operating the three-phase electrical device via un-rectified three-phase electric power supplied by the alternator; and
regulating the un-rectified three-phase electric power supplied by the alternator using a controller according to a predetermined schedule.

11. The method of claim 10, wherein the three-phase electrical device is an electric motor for a fluid pump, and supplying un-rectified three-phase electric power via the alternator supplies fluid to the engine.

12. The method of claim 10, wherein the vehicle additionally includes an exhaust catalyst and a heating, ventilation, and air conditioning (HVAC) system, and the three-phase electrical device is a resistance heater adapted to supply un-rectified three-phase electric power via the alternator to provide thermal energy to at least one of oil in the transmission, oil in the engine, the exhaust catalyst, and air supplied by the HVAC system.

13. The method of claim 10, further comprising ceasing to supply power to the alternator when the engine is off.

14. The method of claim 10, further comprising supplying rectified power by the alternator via a rectifier.

15. The method of claim 10, wherein the engine includes an automatic start/stop capability, the alternator is a belt-driven alternator-starter (BAS) configured to start the engine, and regulating the un-rectified three-phase electric power includes starting the engine via the BAS.

16. A system for controlling a three-phase electrical device in a vehicle, the system comprising:
an internal combustion engine configured to generate engine power;
a transmission operatively connected to the engine and configured to transmit the engine power for driving the vehicle; and
an alternator operatively connected to the engine, the alternator configured to operate on three-phase electric power, to be driven by the engine, and to cease supplying power when the engine is off; and
a controller adapted to regulate the three-phase electric power according to a predetermined schedule for:
powering the alternator via the engine; and
directly operating a three-phase electrical device via un-rectified three-phase electric power supplied by the alternator.

17. The system of claim 16, wherein the three-phase electrical device is an electric motor for a fluid pump, and supplying un-rectified three-phase electric power via the alternator supplies fluid to the engine.

18. The system of claim 16, wherein the hybrid-electric vehicle additionally includes an exhaust catalyst and a heating, ventilation, and air conditioning (HVAC) system, and the three-phase electrical device is a resistance heater adapted to supply un-rectified three-phase electric power via the alternator to provide thermal energy to at least one of oil in the transmission, oil in the engine, the exhaust catalyst, and air supplied by the HVAC system.

19. The system of claim 16, wherein the controller is further adapted for regulating supplying rectified power by the alternator via a rectifier to an energy-storage device.

20. The system of claim 16, wherein the engine includes an automatic start/stop capability, the alternator is a belt-driven alternator-starter (BAS) configured to start the engine, and the controller is additionally adapted to regulate the three-phase electric power for starting the engine via the BAS.
